(19) United States
(12) Patent Application Publication
(10) Pub. No.: US 2008/0277495 A1
(43) Pub. Date: Nov. 13, 2008

(54) Piezoelectric spraying system and corresponding refill

(76) Inventor: Nicolas Duru, Paris (FR)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/004,073

(22) Filed: Dec. 20, 2007

Related U.S. Application Data
(60) Provisional application No. 60/885,564, filed on Jan. 18, 2007.

(30) Foreign Application Priority Data
Dec. 20, 2006 (FR) 06/55746

(51) Int. Cl. B05B 1/08

(52) U.S. Cl. 239/102.2

(57) ABSTRACT

A piezoelectric spraying system may include a case defining at least one housing to receive at least one removable refill. The removable refill may include at least one reservoir configured to contain a product to be sprayed, at least a portion of at least one piezoelectric sprayer device, and at least one product supply system for the piezoelectric sprayer device. The piezoelectric spraying system may further include an electric motor so as to activate the product supply system of the removable refill, and a controller configured to control one or more operations associated with the motor and the piezoelectric sprayer device.

This application claims priority under 35 U.S.C. § 119 to U.S. Provisional Application No. 60/885,564, filed Jan. 18, 2007, the contents of which are incorporated herein by reference. This application also claims benefit of priority under 35 U.S.C. § 119 to French Patent Application No. 06 55746, filed Dec. 20, 2006, the contents of which are also incorporated by reference.

The present disclosure relates to a piezoelectric spraying system and a refill for such a system.

### BACKGROUND

Piezoelectric spraying devices have generally been used for spraying low viscosity liquids (e.g., room perfumes). A wick or other device, acting through capillarity, typically enables a supply of a fluid to a membrane set into vibration by a piezoelectric ceramic. However, such devices have not been suitable for spraying fluids that are more viscous, such as certain cosmetic products (e.g., foundation makeup, tanning solutions, etc.).

International Patent Application No. WO 2005/075095 discloses an electrostatic sprayer system including a pump for feeding a sprayer end-piece, within which the fluid is subjected to an electric field. However, such a sprayer system presents at least the drawback that it requires a special formulation for the fluid to make it suitable for being polarized and dispersed under the effect of the electric field.

The present disclosure may address some or all of these problems.

### SUMMARY

In the following description, certain aspects and embodiments will become evident. It should be understood that the present invention, in its broadest sense, could be practiced without having one or more features of these aspects and embodiments. It should be understood that these aspects and embodiments are merely exemplary.

In one exemplary aspect, a piezoelectric spraying system may include a case defining at least one housing to receive at least one removable refill. The removable refill may include at least one reservoir configured to contain a product to be sprayed, at least a portion of at least one piezoelectric sprayer device, and at least one product supply system for the piezoelectric sprayer device. The piezoelectric spraying system may further include an electric motor housed in the case so as to activate the product supply system of the removable refill, and a controller (e.g., a control circuit) configured to control one or more operations associated with the motor and the piezoelectric sprayer device.

Another exemplary aspect may relate to a refill for a piezoelectric spraying system. The refill may include at least one reservoir configured to contain a product to be sprayed, at least a portion of a piezoelectric sprayer device, and at least one product supply system associated with the piezoelectric sprayer device, wherein the product supply system comprises at least one movable member configured to cause the product to flow from the reservoir towards the piezoelectric sprayer device.

In yet another exemplary aspect, a piezoelectric spraying system may include a case including at least one housing, a piezoelectric element associated with the case, and at least one removable refill configured to be received by the housing. The refill may include at least one reservoir containing a cosmetic product to be sprayed, a membrane portion of a piezoelectric sprayer device, and at least one product supply system comprising a pump configured to supply the cosmetic product to a product supply chamber associated with the piezoelectric sprayer device. The piezoelectric spraying system may further include a motor associated with the case, wherein the motor is configured to actuate the product supply system, and a controller configured to control one or more operations associated with the motor and the piezoelectric sprayer device. A portion of the piezoelectric spraying system may comprise a piezoelectric element, and the membrane portion may be configured to cooperate with the piezoelectric element to cause vibration of the membrane portion.

In some embodiments of the present disclosure, a piezoelectric sprayer device may include a membrane configured to vibrate. The piezoelectric sprayer device may further include a piezoelectric element for causing the membrane to vibrate. The piezoelectric element may include a ceramic material and may enable the conversion of a voltage (e.g., sinusoidal signal voltage) into vibrations. In some embodiments, the piezoelectric element may be supported by and affixed to the refill. Alternatively, the piezoelectric element may be supported by the case.

In some embodiments, the product supply system may comprise a pump. The pump may be configured to, when switched off, substantially terminate fluid communication between the chamber and the reservoir, which may contribute to improving the conservation of the product, in particular when said product comprises one or more volatile solvents. The pump may comprise for example, two rotary members, for example of oval shape. In other embodiments, the rotary members may include teeth or similar elements for inducing flow in a fluid.

The two rotary members may turn in contact with each other. Where the rotary members are implemented without teeth, additional elements may be provided to substantially prevent one rotary member from sliding against the other (e.g., friction pads or an adapted mechanical link).

The refill may comprise a product supply chamber for the piezoelectric spraying. The product supply chamber may be configured to receive the product to be sprayed and may be at least partially defined by the vibrating membrane of the piezoelectric sprayer device.

In one exemplary embodiment of the present disclosure, operation of the piezoelectric sprayer device may be disrupted after a flow direction of the product has been reversed, such that flow is directed away from the product supply chamber. This may assist in emptying of the product supply chamber by enabling the piezoelectric sprayer device to spray a residual amount of the product. Further, in some embodiments, the piezoelectric spraying may be activated at the beginning of a spraying cycle before the product is put into circulation. This may improve a distribution associated with the sprayed product by enabling the piezoelectric spraying to reach a relatively stable operating condition before the actual spraying.

The reservoir may comprise a flexible pocket, which may facilitate the withdrawal of the product in the reservoir without air intake. The case may further comprise a base portion housing the motor and a removable lid affixed to the base portion. The lid may further comprise an opening through which the product may be sprayed. In addition, the case and/or lid may comprise on the top, a button enabling triggering of a spraying cycle.

In some embodiments, the case may be arranged to receive at least a first and a second refill containing a first and a second product respectively. The piezoelectric spraying system may further comprise a first and a second motor, corresponding to the first and second refills. The controller may then be configured to control the motors based on parameters associated with the first and second products (e.g., relative proportions of the first and second products to be sprayed). The products may be withdrawn from the reservoirs without substantial air intake.

The length of time the product flows towards the product supply chamber can be measured. An audible and/or visual signal may be emitted as a function of the length of time the product has been flowing to inform the user about the degree to which the reservoir has been emptied.

In some embodiments, the product may include any cosmetic or care product, for example, a makeup composition, in particular a foundation, or a tanning product (e.g., a self-tanning composition), or a skin care product.

Utilizing exemplary systems and methods of the present disclosure, a product, including relatively viscous fluids, may be sprayed by the piezoelectric sprayer device. Further, exemplary systems and methods of the present disclosure may enable the user to spray a desired product, based on a selected refill, with a large spray pattern of product.

### BRIEF DESCRIPTION OF THE DRAWINGS

The accompanying drawings, which are incorporated in and constitute a part of this specification, illustrate a number of exemplary features of non-limiting embodiments of the invention and together with the description, serve to explain the principles of the invention. In the drawings,

FIG. 1 is a perspective view of an exemplary piezoelectric spraying system consistent with one embodiment of the present disclosure;

FIG. 2 shows an exemplary refill associated with the piezoelectric spraying system of FIG. 1;

FIG. 3 is a profile view highlighting the area indicated by the arrow III of FIG. 2;

FIG. 4 is a rear view highlighting the area indicated by the arrow IV of FIG. 3;

FIG. 5 is a diagram showing an exemplary pump according to some embodiments of the invention;

FIG. 6 is a diagram showing an exemplary product supply chamber of a piezoelectric sprayer device and an exemplary pump associated with the exemplary product supply chamber;

FIG. 7 is a block diagram showing exemplary components of the piezoelectric spraying system;

FIG. 8 is a cross-section view of another exemplary pump according to another embodiment of the disclosure;

FIG. 9 is a perspective view of a section of a piezoelectric spraying system consistent with embodiments of the current disclosure;

FIG. 10 is a perspective view of a section of another piezoelectric spraying system consistent with embodiments of the current disclosure;

FIG. 11 is a block diagram showing an exemplary sequence of a spray cycle;

FIG. 12 is an exemplary piezoelectric sprayer device; and

FIG. 13 is another exemplary piezoelectric sprayer device.

### DESCRIPTION

Reference will now be made in detail to exemplary embodiments of the invention, examples of which are illustrated in the accompanying drawings. Wherever possible, the same reference numbers will be used throughout the drawings to refer to the same or like parts. It is to be understood that both the foregoing general description and the following detailed description are exemplary and explanatory only and are not restrictive of the invention, as claimed.

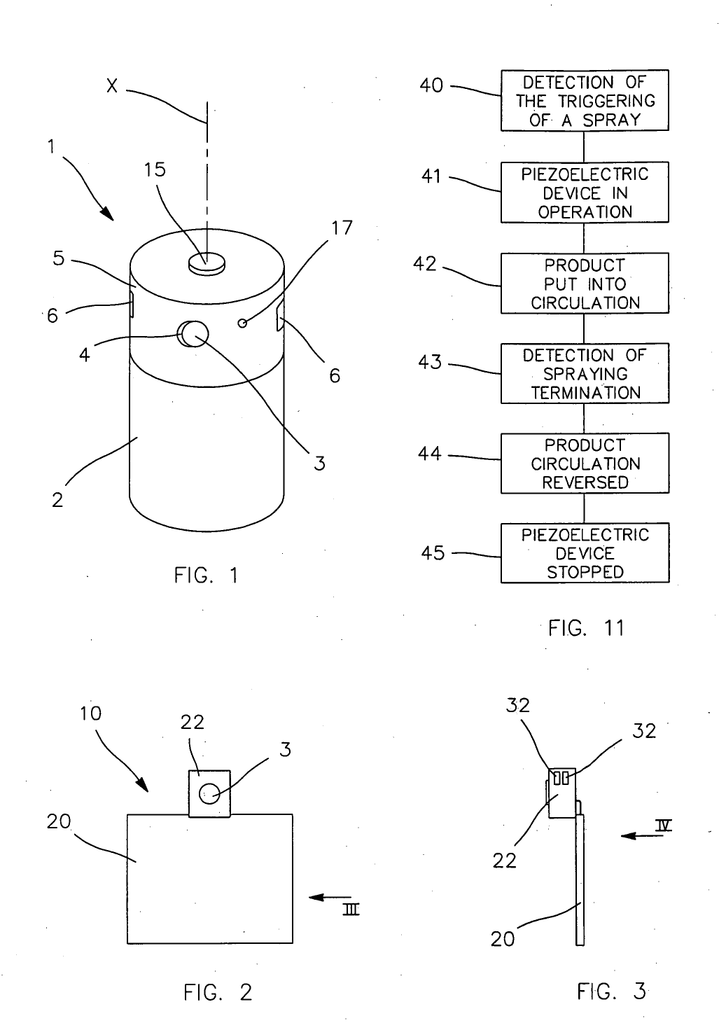

A piezoelectric spraying system 1 shown in FIG. 1 may include a case 2 containing a piezoelectric sprayer device 3, which may enable a product to be sprayed through an opening 4 of the case 2. For example, opening 4 may be a front opening with an axis extending perpendicularly to the longitudinal axis X of case 2, as shown in FIG. 1. In such an example, opening 4 may be formed in a removable cap 5, which can be separated from the base of the housing by acting on unlocking tabs 6 (e.g., diametrically opposite tabs). Removing cap 5 may allow access to a refill 10 similar to that shown in FIGS. 2 to 4. Other embodiments and configurations associated with case 2 are possible and intended to fall within the scope of the present disclosure.

As shown diagrammatically in FIG. 7, piezoelectric spraying system 1 may include a power source 11 (e.g., one or more batteries or other electrical source), which may be accessible under cap 5 and/or by removing a cover (not shown) to enable replacement of the power source. In some embodiments, power source 11 may be integrated within refill 10.

Piezoelectric spraying system 1 also may include a controller 12 that may control the operation of a motor 13 and the operation of piezoelectric sprayer device 3 during a spray cycle, as described in detail below.

In some exemplary embodiments, piezoelectric spraying system 1 may include a pushbutton 15, which may be situated in a top portion of case 2. Pushbutton 15 may pass through a corresponding opening formed in cap 5. Alternatively, pushbutton 15 may be located at any suitable position on case 2 (e.g., a side portion of case 2 or cap 5).

Piezoelectric spraying system 1 also may include at least one visual alarm 17 (e.g., including a light-emitting diode (LED)) and/or an audible alarm (not shown) (e.g., including a speaker)), and may include at least one inclinometer 19 shown diagrammatically in FIG. 7. For example, a visual alarm 17 may include an LED that changes color or that flashes when the reservoir 20 is empty or nearly empty. Visual alarm 17 can also be actuated to indicate that the device is operating properly. Audible alarm may be configured to emit an audible warning (e.g., play a sound file and/or emit a “beep”). One of skill in the art will recognize that other variations on alarms may be implemented without departing from the scope of the present invention.

Exemplary embodiments of a piezoelectric sprayer device 3 are shown in FIGS. 12 and 13. Piezoelectric sprayer device 3 may include a piezoelectric element 70 of piezoelectric material, and a membrane 71. Membrane 71 may be a perforated membrane, sometimes called a grid, which may be mechanically stressed in vibration by piezoelectric element 70. Piezoelectric element 70 may include a ring comprising a ceramic material for example, in particular zirconate (PZT), metaniobate (PN), barium titanate or zinc oxide. French Patent Application No. FR 2 886 174 discloses an example of such a piezoelectric element.

Piezoelectric sprayer device 3 may be supported by refill 10, and therefore, both the piezoelectric element 70 and the membrane 71 may be present within refill 10. Alternatively, refill 10 may include membrane 71, but may not include piezoelectric element 70, piezoelectric element 70 instead being associated with case 2. In such an embodiment, piezoelectric element 70 may be configured to become operably connected to membrane 71 upon insertion of refill 10 into housing 22, thus enabling the vibration of membrane 71 by piezoelectric element 70. U.S. Pat. No. 4,702,418 discloses an example of such a device.

Membrane 71 may have a diameter greater than or equal to 6 millimeters (mm), and in some cases may be equal to 7 mm. Further, membrane 71 may have more than 100 perforations, and in one embodiment may have 150 perforations. Further the perforations may have a diameter lying in a range of 20 micrometers (μm) to 40 μm, and in one embodiment may have a diameter equal to approximately 30 μm. Moreover, the perforations may be situated in a central region of membrane 71. One of ordinary skill in the art will recognize that desired diameter and locations associated with the perforations may vary slightly in any particular implementation without departing from the scope of the present disclosure.

Piezoelectric element 70 may have thickness lying in a range of 0.5 mm to 0.7 mm. In one example, a thickness associated with piezoelectric element 70 may be approximately 0.6 mm, with an outside diameter that is approximately equal to 20 mm and an inside diameter that is approximately equal to 5 mm.

Controller 12 may be configured to deliver an excitation current to piezoelectric element 70 and may include electronic components enabling such excitation at a resonant frequency associated with piezoelectric element 70. For example, piezoelectric element 70 may be excited, by a sinusoidal voltage at 100 kilohertz (kHz) with a peak-to-peak amplitude of 100 millivolts (mV). One of ordinary skill in the art will recognize that different sizes and materials may be associated with different resonant properties. Therefore, any such variations are intended to fall within the scope of the present disclosure.

As shown in FIG. 2, refill 10 may include a reservoir 20, for example, in the form of a pocket of flexible material containing at least one product for dispensing. The product can be taken from the reservoir 20 without any air intake, where desired. In such an embodiment, refill 10 further may include piezoelectric sprayer device 3, which may be contained in a housing 22 secured to the reservoir 20. Further, reservoir 20 may be configured to enable refilling with a product, and may comprise an opening for that purpose.

Housing 22 may also include a pump 26 (e.g., a rotary pump) that may be configured to cause the product to flow from the reservoir 20 towards a product supply chamber 27 for feeding the piezoelectric sprayer device 3. Alternatively, pump 26 may be contained within reservoir 20, or any other suitable location associated with piezoelectric spraying system 1. In one example, pump 26 may include two rotary members 28 and 29 that may rotate in contact with each other. Such a configuration may enable a termination of fluid communication between product supply chamber 27 and reservoir 20 while pump 26 is at rest (i.e., not operating).

Product supply chamber 27 may be defined on one side by membrane 71 and may have an associated volume of less than or equal to 1 milliliter (mL). In one example, a volume associated with product supply chamber 27 may lie in a range of 0.25 mL to 0.75 mL. Further, a mass rate of flow of product to product supply chamber 27 during spraying may lie in a range of 0.1 grams per minute (g/min) to 5 g/min. In one example, a mass rate of product flow to the product supply chamber 27 may lie in a range of 0.7 g/min to 0.9 g/min.

Product supply chamber 27 may be fed by a conduit 48 located at a position associated with a bottom portion of product supply chamber 27 when the piezoelectric sprayer device is in a substantially upright position. Conduit 48 may be of small cross section and may be in fluid communication with pump 26 and reservoir 20.

Piezoelectric sprayer device 3 may be manufactured to various specifications, for example membrane 71 may include any shape. Therefore, the present disclosure is not limited to a piezoelectric sprayer device having any particular shape. Further, the shape of product supply chamber 27 may depend on the shape of membrane 71 associated with piezoelectric sprayer device 3. For example, in one embodiment, piezoelectric sprayer device 3 can include a shape similar to that disclosed in International Patent Application No. WO 91/16997.

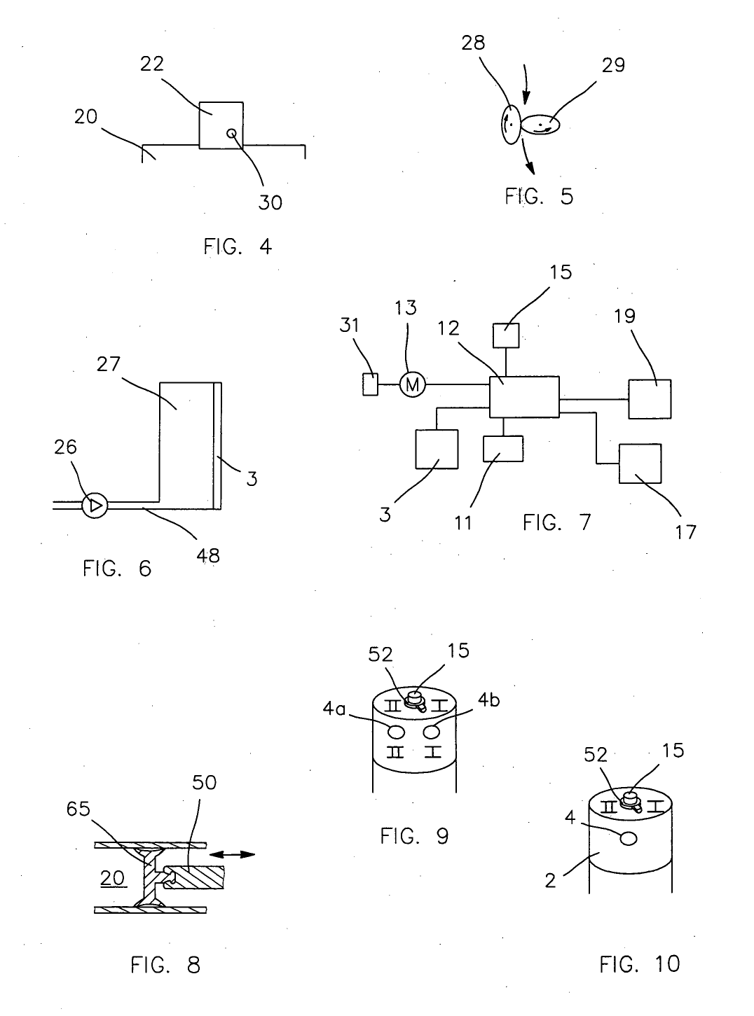

Pump 26 may be driven by a second coupling member 30 that may be accessible from one of the faces of the housing 22 as shown in FIG. 4. First coupling member 31 may be configured to be driven by the motor 13 as shown diagrammatically in FIG. 7. Further first coupling member 31 may be arranged to co-operate with second coupling member 30 resulting in transmission of rotation from motor 13 via first and second coupling members 31 and 30 to rotary members 28 and 29, thereby actuating pump 26. Step-down gearing between motor 13 and first coupling member 31 may be implemented as desired (e.g., where a viscous fluid is used).

Housing 22 also may include power transmission elements 32 (e.g., electrical conductors) configured to provide power to piezoelectric sprayer device 3. Case 2 may contain corresponding power transmission elements connected to controller 12 for purposes of receiving power. Therefore, power transmission elements 32 may be powered by controller 12 while refill 20 is present in case 2. Motor 13 may then be provided power by controller 12, thereby causing first and second coupling members 31 and 30 to co-operate resulting in actuation of pump 26.

Inclinometer 19 may be used to sense an inclination associated with piezoelectric spraying system 1. Inclinometer 19 may provide controller 12 with information related to the inclination associated with piezoelectric spraying system 1. Controller 12 may be arranged to inform the user, for example, by actuating visual alarm 17 or audible alarm (not shown), that sprayer system 1 is not in the best orientation for emptying product supply chamber 27, and that it could be placed more upright as shown in FIG. 6.

Where appropriate, controller 12 can also monitor the length of time motor 13 operates while driving pump 26 to deliver product to product supply chamber 27. This operating time can then be compared with a predefined value, and controller 12 can be arranged to warn the user that the reservoir is about to be emptied, e.g. by emitting a sound and/or light signal.

FIG. 11 is a block diagram showing an exemplary sequence of a spray cycle. Actuation of pushbutton 15 may be detected by controller 12 (step 40). Controller 12 may then cause piezoelectric sprayer device 3 to operate (step 41), and subsequently provide power to motor 13 so as to cause the product to flow towards the product supply chamber 27 (step 42).

Spraying of the product may take place so long as the user continues to depress pushbutton 15, or alternatively, a predetermined spraying duration may be stored in controller 12 and used for automatically terminating spraying. When release of pushbutton 15 is detected, piezoelectric sprayer device 3 may continue to operate while a direction of rotation associated with motor 13 is reversed (step 43). This may cause pump 26 to reverse a flow direction associated with the product, thereby substantially emptying product supply chamber 27. After a predetermined duration, operation of piezoelectric sprayer device 3 may be stopped (step 45).

A product even relatively viscous may be sprayed repeatedly by piezoelectric spraying system 1, as the drying-out and the formation of a significant solid deposit of the product in product supply chamber 27, between two spaced-out uses, is avoided. Further, once emptied, refill 10 may be removed and replaced by a new refill, of which the reservoir 20 may contain a new product to be sprayed.

The present disclosure is not limited to one particular drive means for causing the product to flow towards the product supply chamber 27 from the reservoir 20 or in the opposite direction, and various types of pumps 26 can be used. For example, it may be possible to use a peristaltic pump, a gear pump, and/or a screw pump, among other things.

Reservoir 20 can also be defined at least in part by a piston 65, as shown in FIG. 8, and motor 13 can serve to drive a pusher 50 that enables the piston 65 to be moved in one direction or the other, depending on whether it is desired to feed the product supply chamber 27 or to empty it.

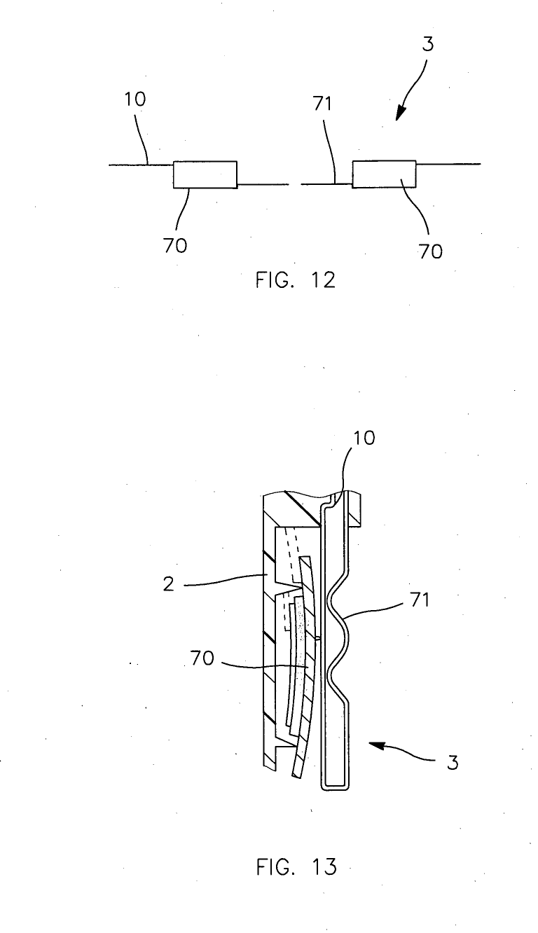

It is not intended that the present disclosure be limited to spraying a single product. For example, case 2 may receive at least two refills, each of which may be associated with a respective piezoelectric sprayer device 3. In such an embodiment, case 2 may include two openings 4a and 4b for spraying each of the two products, as shown in FIG. 9. Alternatively, the at least two refills may be associated with a single piezoelectric sprayer device 3 and single opening 4 in case 2 (as shown in FIG. 10).

Piezoelectric spraying system 1 may further include a selector 52 that may enable a user to select one or more of the products, to be sprayed individually or simultaneously at a ratio determined by the user. In such an example, controller 12 may control respective motors 13 driving associated pumps 26 at different speeds of rotation, depending on, for example, a function of the relative proportions of the product that are to be delivered. In such an embodiment, piezoelectric spraying system 1 may include two or more reservoirs 20, each containing a product for spraying. Corresponding pumps 26 may then both feed a single product supply chamber 27 associated with piezoelectric sprayer device 3.

In other embodiments, piezoelectric spraying system 1 may not have a removable refill 10. In such an embodiment, reservoir 20 may be configured to be affixed to case 2 of piezoelectric spraying system 1, and may be capable of being refilled with product. Pump 26, used for delivering product to product supply chamber 27 of piezoelectric sprayer device 3, may also be used for filling reservoir 20. For example, a selector may be provided allowing pump 26 to draw product from a source configured to fill reservoir 20.

Further, refill 10 may include means for informing case 2 and or controller 12 about a state of the product contained therein. For example, contacts associated with refill 10 may cooperate with contacts in housing 22, and a state associated with the contacts (e.g., an electrical signal conveyed by the contacts) may then be analyzed by controller 12.

Refill 10 also may include an electronic memory and/or a bar code that may store information related to the product contained inside it (e.g., identity of product, product spray conditions, quantity of product, rate at which piezoelectric sprayer device 3 should be fed, etc).

One of ordinary skill in the art will recognize upon review of the present disclosure that any type of piezoelectric sprayer devices adapted to spray the concerned product may be used. The piezoelectric sprayer devices described herein are intended as examples and are not intended to be limiting.

Throughout this disclosure, the term “comprising a” should be understood as being synonymous with “comprising at least one” unless specified to the contrary. In addition, any range set forth in the description, including the claims should be understood as including its end value(s).

Further, although the present disclosure herein has been described with reference to particular embodiments, it is to be understood that these embodiments are merely illustrative of the principles and applications of the present disclosure. It is therefore to be understood that numerous modifications may be made to the illustrative embodiments and that other arrangements may be devised without departing from the present disclosure.

What is claimed is:

1. A piezoelectric spraying system, comprising:
a case defining at least one housing to receive at least one removable refill, the removable refill comprising
at least one reservoir configured to contain a product to be sprayed,
at least a portion of at least one piezoelectric sprayer device, and
at least one product supply system for the piezoelectric sprayer device;
an electric motor housed in the case so as to activate the product supply system of the removable refill; and
a controller configured to control one or more operations associated with the motor and the piezoelectric sprayer device.

2. The system according to claim 1, wherein the piezoelectric sprayer device comprises:
a membrane configured to be vibrated, wherein the membrane being a portion of the removable refill; and
a piezoelectric element configured to cause vibration of the membrane.

3. The system according to claim 2, wherein the piezoelectric element is a portion of the removable refill and is operably connected to the membrane.

4. The system according to claim 2, wherein the piezoelectric element is a portion of the case.

5. The system according to claim 1, wherein the product supply system comprises a pump.

6. The system according to claim 5, wherein the pump comprises two rotary members configured to be substantially in contact with each other during rotation of the rotary members.

7. The system according to claim 1, wherein the removable refill further comprises a product supply chamber associated with the piezoelectric sprayer device.

8. The system according to claim 1, wherein the reservoir comprises a pocket of flexible material.

9. The system according to claim 1, wherein the case comprises:
a base portion configured to house the motor; and
a removable lid including an opening through which the product is sprayed.

10. The system according to claim 1, wherein a top portion of the case comprises a pushbutton configured to trigger a spraying cycle.

11. The system according to claim 1, further comprising a product contained in the reservoir, wherein the product includes a cosmetic product.

12. The system according to claim 1, further comprising a product contained in the reservoir, wherein the product includes a makeup product.

13. The system according to claim 1, further comprising a product contained in the reservoir, wherein the product includes a tanning product.

14. The system according to claim 1, wherein the case is arranged to receive at least a first and a second removable refill containing a first and a second product respectively, and wherein the system further comprises:
a first motor corresponding to the first removable refill; and
a second motor corresponding to the second removable refill, wherein the controller is configured to control the first and second motors according to parameters associated with the first and second products.

15. The system according to claim 1, wherein the controller is configured to determine a duration associated with the one or more operations, and based on the determination, provide information indicative of at least one state associated with the piezoelectric spraying system.

16. The system according to claim 1, wherein the product is non-polarisable.

17. A refill for a piezoelectric spraying system, comprising:
at least one reservoir configured to contain a product to be sprayed;
at least a portion of at least one piezoelectric sprayer device; and
at least one product supply system associated with the piezoelectric sprayer device, wherein the product supply system comprises at least one movable member configured to cause the product to flow from the reservoir towards the piezoelectric sprayer device.

18. The refill according to claim 17, wherein the portion of the piezoelectric sprayer device includes a membrane configured to vibrate.

19. The refill according to claim 18, wherein the portion of the piezoelectric sprayer device further includes a piezoelectric element operably connected to the membrane and configured to cause the membrane to vibrate.

20. The refill according to claim 18, wherein the refill does not include a piezoelectric element.

21. The refill according to claim 17, wherein the product supply system comprises a pump.

22. The refill according to claim 21, wherein the pump comprises two rotary members configured to be substantially in contact with each other during rotation of the rotary members.

23. The refill according to claim 17, wherein the refill comprises a product supply chamber associated with the piezoelectric sprayer device.

24. The refill according to claim 17, wherein the reservoir comprises a pocket of flexible material.

25. The refill according to claim 17, further comprising a product contained in the reservoir, wherein the product includes a cosmetic product.

26. The refill according to claim 17, further comprising a product contained in the reservoir, wherein the product includes a makeup product.

27. The refill according to claim 17, further comprising a product contained in the reservoir, wherein the product includes a tanning product.

28. The refill according to claim 17, further comprising a product contained in the reservoir, wherein the product includes a non-polarizable product.

29. A piezoelectric spraying system, comprising:
a case including at least one housing;
at least one removable refill configured to be received by the housing, wherein the removable refill comprises
at least one reservoir containing a cosmetic product to be sprayed,
a membrane portion of a piezoelectric sprayer device, and
at least one product supply system comprising a pump configured to supply the cosmetic product to a product supply chamber associated with the piezoelectric sprayer device;
a motor associated with the case, wherein the motor is configured to actuate the product supply system; and
a controller configured to control one or more operations associated with the motor and the piezoelectric sprayer device;
wherein a portion of the piezoelectric spraying system comprises a piezoelectric element;
wherein the membrane portion is configured to cooperate with the piezoelectric element to cause vibration of the membrane portion.
